(19) United States
(12) Patent Application Publication
(10) Pub. No.: US 2024/0175702 A1
(43) Pub. Date: May 30, 2024

(54) NAVIGATION METHOD AND APPARATUS, STORAGE MEDIUM, AND DEVICE

(71) Applicant: BEIJING YOUZHUJU NETWORK TECHNOLOGY CO., LTD., Beijing (CN)

(72) Inventors: Taozheng YANG, Beijing (CN); Tao KONG, Beijing (CN); Lei LI, Beijing (CN)

(21) Appl. No.: 18/552,608

(22) PCT Filed: Mar. 30, 2022
(86) PCT No.: PCT/CN2022/084027

§ 371 Date: Sep. 26, 2023

(30) Foreign Application Priority Data
Apr. 19, 2021 (CN) 202110420519.5

(51) Int. Cl. G01C 21/00

(52) U.S. Cl. CPC G01C 21/38

(57) ABSTRACT

Provided are a navigation method and apparatus, a storage medium, and a device. The method includes the steps below. A global planning path in a target map is determined according to a current position of a robot and an end position in a navigation request. An initial local path corresponding to the global planning path is determined based on a local planning range. The local planning range corresponds to the boundary of a local costmap. The local costmap includes obstacle information within the local planning range. A local planning path corresponding to the initial local path is generated according to the initial local path and the local costmap. A navigation control instruction of the robot is generated according to the local planning path and a preset robot model corresponding to the robot.

### CROSS-REFERENCE TO RELATED APPLICATIONS

This is a national stage application filed under 37 U.S.C. 371 based on International Patent Application No. PCT/CN2022/084027, filed Mar. 30, 2022, which claims priority to Chinese Patent Application No. 202110420519.5 filed with the CNIPA on Apr. 19, 2021, the disclosures of which are incorporated herein by reference in their entireties.

### TECHNICAL FIELD

Embodiments of the present disclosure relate to the field of computer technologies, and for example, a navigation method and apparatus, a storage medium, and a device.

### BACKGROUND

A robot is an intelligent machine that can work semi-autonomously or fully autonomously. With the development of robot technologies, robots continuously evolve in various aspects such as mechanical structure, function, and appearance.

Currently, the robots of different types are widely used in various fields, where one type of robots can implement autonomous movement. To enable the robot to move autonomously, a navigation system for the robot is particularly important. The navigation system is generally responsible for path planning and movement control of the robot.

The navigation solution of a navigation system in a related art is not perfect enough, making the robot often stuck or vibrated during the movement, and requiring improvement.

### SUMMARY

Embodiments of the present disclosure provide a navigation method and apparatus, a storage medium, and a device to optimize the navigation solution of the robot in a related art.

In a first aspect, an embodiment of the present disclosure provides a navigation method. The method includes the steps below.

A global planning path in a target map is determined according to a current position of a robot and an end position in a navigation request.

An initial local path corresponding to the global planning path based on a local planning range is determined. The local planning range corresponds to the boundary of a local costmap. The local costmap includes obstacle information within the local planning range.

A local planning path corresponding to the initial local path is generated according to the initial local path and the local costmap.

A navigation control instruction of the robot is generated according to the local planning path and a preset robot model corresponding to the robot.

In a second aspect, an embodiment of the present disclosure provides a navigation apparatus. The apparatus includes a global planning path determination module, an initial local path determination module, a local planning path generation module, and a navigation control instruction generation module.

The global planning path determination module is configured to determine a global planning path in a target map according to a current position of a robot and an end position in a navigation request.

The initial local path determination module is configured to determine an initial local path corresponding to the global planning path based on a local planning range. The local planning range corresponds to the boundary of a local costmap. The local costmap includes obstacle information within the local planning range.

The local planning path generation module is configured to generate a local planning path corresponding to the initial local path according to the initial local path and the local costmap.

The navigation control instruction generation module is configured to generate a navigation control instruction of the robot according to the local planning path and a preset robot model corresponding to the robot.

In a third aspect, an embodiment of the present disclosure provides a computer-readable storage medium storing a computer program which, when executed by a processor, implements the navigation method provided in the embodiments of the present disclosure.

In a fourth aspect, an embodiment of the present disclosure provides an electronic device, including a memory, a processor, and a computer program stored in a memory and executable on the processor. The processor, when executing the computer program, implements the navigation method provided in the embodiments of the present disclosure.

### BRIEF DESCRIPTION OF DRAWINGS

FIG. 1 is a flowchart of a navigation method according to an embodiment of the present disclosure;

FIG. 2 is a flowchart of another navigation method according to an embodiment of the present disclosure;

FIG. 3 is a schematic diagram of a global planning path according to an embodiment of the present disclosure;

FIG. 4 is a schematic diagram of an initial local path according to an embodiment of the present disclosure;

FIG. 5 is a schematic diagram of a local planning path according to an embodiment of the present disclosure;

FIG. 6 is a schematic diagram of a robot trajectory according to an embodiment of the present disclosure;

FIG. 7 is a flowchart of another navigation method according to an embodiment of the present disclosure;

FIG. 8 is an architecture diagram of a navigation method according to an embodiment of the present disclosure;

FIG. 9 is a block diagram of a navigation apparatus according to an embodiment of the present disclosure; and

FIG. 10 is a block diagram of an electronic device according to an embodiment of the present disclosure.

### DETAILED DESCRIPTION

Embodiments of the present disclosure are described in more detail hereinafter with reference to the drawings. Although some embodiments of the present disclosure are shown in the drawings, it is to be understood that the present disclosure may be implemented in various forms and should not be construed as limited to the embodiments set forth herein; conversely, these embodiments are provided so that the present disclosure will be thoroughly and completely understood. It is to be understood that the drawings and embodiments of the present disclosure are merely illustrative and are not intended to limit the scope of the present disclosure.

It should be understood that steps described in the method embodiments of the present disclosure may be performed in sequence and/or in parallel. Additionally, the method embodiments may include additional steps and/or omit some of the illustrated steps. The scope of the present disclosure is not limited in this respect.

The term “includes” or its variant used herein means “includes, but is not limited to”. The term “based on” means “at least partially based on”. The term “an embodiment” means “at least one embodiment”. The term “another embodiment” means “at least one other embodiment”. The term “some embodiments” means “at least some embodiments”. Definitions of other terms are given in the description hereinafter.

It is to be noted that concepts such as “first” and “second” in the present disclosure are merely intended to distinguish between apparatuses, between modules, or between units and are not intended to limit the order or mutual dependence of the functions performed by these apparatuses, modules, or units.

It is to be noted that references to modifications of “one” or “multiple” mentioned in the present disclosure are intended to be illustrative and not limiting, and that those skilled in the art should understand that “one” or “multiple” should be understood as “at least one” unless clearly expressed in the context.

The names of messages or information exchanged between apparatuses in the embodiments of the present disclosure are only used for illustrative purposes and are not intended to limit the scope of the messages or information.

Optional characteristics and examples are provided in each of the multiple embodiments described below. Multiple characteristics described in the embodiments may be combined to form multiple example solutions. Each numbered embodiment should not be regarded as only one solution.

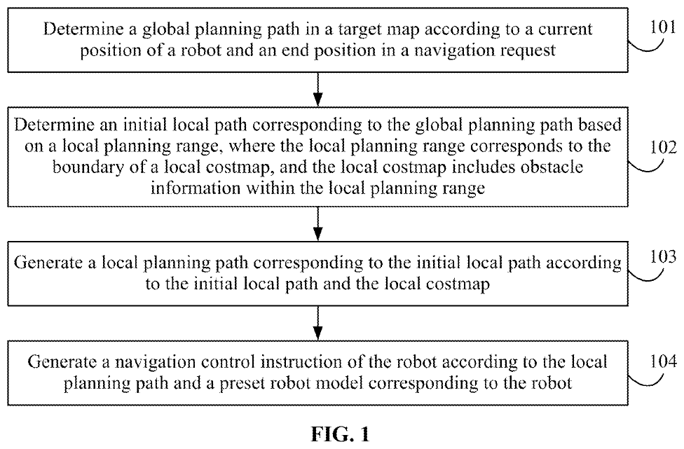

FIG. 1 is a flowchart of a navigation method according to an embodiment of the present disclosure. The method may be applicable to the case of navigating a robot. The method may be executed by a navigation apparatus. The apparatus may be implemented by software and/or hardware and generally integrated into an electronic device. The robot may be an autonomous mobile robot. The electronic device may be the robot itself or an independent device having a navigation function and capable of communicating with the robot. The present disclosure is not specifically limited. For ease of description, the following uses an example where the electronic device is the robot itself for description.

As shown in FIG. 1, the method includes the steps below.

In step 101: a global planning path in a target map is determined according to a current position of a robot and an end position in a navigation request.

In embodiments of the present disclosure, the specific mechanical structure, function, appearance, and the like of the robot are not limited. For an autonomous mobile robot, when a task needs to be executed, the robot generally needs to move to a specified position. In this case, the robot may generate a corresponding navigation request and move to a corresponding position according to the navigation request. For example, a distribution robot is used as an example. When a cargo distribution task needs to be executed, the distribution robot needs to deliver a cargo to a place of receipt. In this case, the distribution robot may generate a corresponding navigation request and move to the place of receipt according to the navigation request. The navigation request may be automatically generated when the robot detects that a preset task trigger condition is satisfied or when task information sent by another device is received. The navigation request may include the end position. The end position may correspond to a position that the robot is required to reach in a task to be executed by the robot. The specific representation form of the end position is not limited, for example, may be longitude and latitude coordinates, or position information in a coordinate system where the target map is located. In an exemplary embodiment, the specific representation form of the current position of the robot may be the same as that of the end position. The current position of the robot may be understood as a position of the robot at a moment when the global planning path needs to be determined. It is to be noted that after the navigation request is received, the global planning path may need to be generated multiple times in terms of the navigation request. For example, in the process where the robot moves toward the end position in the navigation request, the global planning path may be determined according to the current position of the robot and the end position in the navigation request in a first preset frequency. The first preset frequency may be set according to the actual requirements.

Exemplarily, the target map is a map within the working range of the robot, and the specific representation form of the target map is not limited. For example, the target map may include a basic map obtained by constructing within the working range of the robot by using a simultaneous localization and mapping (SLAM) technology or another related map construction technology, and may further include a grid-based map or a map based on a topology road network. Maps in different forms may also be superposed on each other to obtain the preceding target map. When the target map is formulated, environment characteristics of a working environment of the robot may be considered. The environment characteristics that need to be considered may be distinguished according to an indoor environment and an outdoor environment. Using the indoor environment as an example, the indoor environment may include positions of static obstacles such as tables, chairs, workbenches, or walls. Using the outdoor environment as an example, the outdoor environment may include positions of static obstacles such as a building position, a road position, a garbage can and a street lamp. The preceding static obstacles may be marked in the target map according to the environment characteristics so that the preceding obstacles that need to be considered may be bypassed when the global planning path is determined.

Exemplarily, the global planning path may be understood as a path capable of connecting the current position of the robot to the end position of the robot in the target map. A global planning path having the shortest length may be determined as the global planning path according to a global planning algorithm. The global planning algorithm may be set according to actual situations.

In step 102: an initial local path corresponding to the global planning path based on a local planning range is determined. The local planning range corresponds to the boundary of a local costmap. The local costmap includes obstacle information within the local planning range.

Exemplarily, to implement more accurate path planning, part of path may be marked off as a reference on the basis of the global planning path to plan the path within a relatively short time or a relatively short distance that the robot is about to travel. That is, the local path planning is performed. The local planning range may be set according to actual situations. For example, the local planning range may be a range preset according to a planning accuracy requirement, or may be a range dynamically determined according to a total length of the global planning path, a coverage range of the global planning path, or a distance between the current position and the end position in the navigation request. It can be understood that, in general, the smaller the local planning range, the higher the planning accuracy. It is to be noted that after the global planning path is determined, the initial local path may need to be determined multiple times in terms of the global planning path. The determined initial local paths determined multiple times may not have an intersection set or may have an intersection set. Each time the initial local path is determined, the position of the robot at a current moment may be used as a reference. For example, the current position is located on the boundary of the local planning range or in the local planning range. Exemplarily, in the process that the robot proceeds to the end position in the navigation request, the initial local path corresponding to the global planning path may be determined based on the local planning range in a second preset frequency. The second preset frequency may be set according to actual requirements and may be generally greater than the first preset frequency.

Exemplarily, within the movement range of the robot, in addition to the static obstacles already considered in the target map, dynamic obstacles (such as humans, animals, vehicles, or other robots) or a newly added static obstacle (such as an added table) may also exist, and the case where the static obstacles already considered in the target map is removed may also exist. Therefore, the local planning path needs to be determined in conjunction with the obstacle information. The obstacle information herein may include at least one of static obstacle information or dynamic obstacle information. In an exemplary embodiment, the obstacle information may be reflected in a costmap manner.

Exemplarily, that the obstacle information includes the dynamic obstacles is used as an example. The robot may locate the position of the robot by using a sensor (such as a laser radar, an odometer, or a camera) or in another manner, and acquire position information of surrounding obstacles to obtain the dynamic obstacle information, i.e. dynamically-changed obstacle information. The frequency of acquiring the obstacle information by the robot may be set according to actual situations. When the frequency is fast enough, the obstacle information may be seen as updated in real time. After the dynamic obstacle information is obtained, the dynamic obstacle information may be projected to a two-dimensional plane (such as a two-dimensional plane where the target map is located) to form the costmap. In the costmap, different colors may be used to distinguish the distance information between different areas and obstacles. For example, a blue area is an area having obstacles, a red area is an area extremely close to the obstacles, a purple area is an area relatively close to the obstacles, and a white area is a safe area far from the obstacles, etc.

Exemplarily, when the local path planning is performed, obstacle information outside the local planning range generally does not affect planning. To improve the generation efficiency of the costmap, the boundary of the costmap may be set to obtain the local costmap. An area enclosed by the boundary of the local costmap may cover the local planning range. That is, the local costmap includes the obstacle information within the local planning range.

In step 103: a local planning path corresponding to the initial local path is generated according to the initial local path and the local costmap.

Exemplarily, the obstacle information included in the local costmap may be considered on the basis of the initial local path so that a path that is close to the initial local path and capable of avoiding the obstacles in the local planning range is obtained as the local planning path. In an exemplary embodiment, a preset search method may be used to generate the local planning path corresponding to the initial local path according to the initial local path and the local costmap.

Exemplarily, the preset search method is generally a graph search method. The graph search method may construct a path from a start point to an end point by using an environment map already known and the obstacle information in the map. For the initial local path, an endpoint closest to the current position of the robot when the global planning path is determined may be used as the start point of the initial local path, and an endpoint closest to the end position in the navigation request may be used as the end point of the initial local path. The preset search method may be a Dijkasta algorithm (the shortest path algorithm), an A* (A-star or A*) algorithm, a D* algorithm or the like, which is not specifically limited. The specific process of generating the local planning path corresponding to the initial local path according to the initial local path and the local costmap by using a preset search algorithm is not limited. For example, that the local planning path approaches the initial local path and avoids the obstacles is used as an objective to perform a search.

In step 104: a navigation control instruction of the robot is generated according to the local planning path and a preset robot model corresponding to the robot.

In an exemplary embodiment, the navigation control instruction may include control instructions corresponding to multiple time points. The control instructions may include, for example, a control instruction corresponding to a velocity, an accelerated velocity, an angular velocity, or an angular acceleration, and may further include a control instruction such as an orientation rotation angle.

In a related technology, when the navigation control instruction of the robot is generated, generally, a path point having a time frame is directly generated based on the determined planning path, and then the navigation control instruction at each moment is obtained by using time information and displacement information corresponding to the adjacent path point and is sent to the robot for execution. The preceding method does not consider characteristics of the robot itself. That is, for different robots, the navigation control instructions are the same. However, for different robots, mechanical structures or driving manners of the robots themselves are different. For the same navigation control instruction, execution results of the robots are different. If the preceding differences are not considered, the robot is often stuck or vibrated during the movement, affecting the flexibility and smoothness of the movement.

In embodiments of the present disclosure, when the navigation control instruction of the robot is generated, the navigation control instruction is generated according to the local planning path and the preset robot model corresponding to the robot. The preset robot model is used for reflecting the characteristics of the robot. The specific type and the presentation form of the preset robot model are not limited. For example, the preset robot model may be one or a combination of at least two of a preset robot mechanical model, a preset robot kinematics model, and a preset robot dynamic model. That is, in embodiments of the present disclosure, the characteristics of the robot are fully considered, and the navigation control instruction that is more suitable for the current robot may be obtained, reducing the probability of the current robot being stuck or vibrated during the movement in the process of executing the navigation control instruction, and ensuring the stability, the security, and the smoothness of the autonomous navigation movement of the robot.

The navigation method provided in embodiments of the present disclosure, first, determines the global planning path in the target map according to the current position of the robot and the terminal position in the navigation request, then, determines the initial local path corresponding to the global planning path based on the local planning range, where the local planning range corresponds to the boundary of the local costmap, and the local costmap includes the obstacle information within the local planning range, then, generates the local planning path corresponding to the initial local path according to the initial local path and the local costmap, and finally, generates the navigation control instruction of the robot according to the local planning path and the preset robot model corresponding to the robot. In the preceding technical solutions, part of the global planning path corresponding to the local planning range is determined as a current initial local path on the basis of the global planning path, and a more accurate local planning path is obtained on the basis of the initial local path in conjunction with the obstacle information. In the process of generating the navigation control instruction according to the local planning path, constraints of the preset robot model corresponding to the robot are considered so that the generated navigation control instruction is more suitable for the characteristics of the robot, avoiding the robot from being stuck or vibrated during the movement according to the navigation control instruction, and improving the smoothness of the autonomous movement of the robot.

In some embodiments, steps related to the global planning may be completed through a first thread, and steps related to the local planning may be completed through a second thread. That is, the global planning and the local planning may be separated, and the first thread and the second thread are different threads. For example, the step 101 is executed through the first thread, and the steps 102 and 103 are executed through the second thread.

In some embodiments, before the step in which the global planning path in the target map is determined according to the current position of the robot and the end position in the navigation request, the method further includes the steps below. A topology road network corresponding to an environment where the robot is located is acquired. The target map is determined according to the topology road network. The environment where the robot is located may include at least one of an outdoor environment or an indoor environment. The environment where the robot is located may be determined according to an actual operation area of the robot. In an exemplary embodiment, the steps in which the topology road network corresponding to the environment where the robot is located is acquired and the target map is determined according to the topology road network may include: acquiring a basic map corresponding to the environment where the robot is located, and superposing the topology road network on the basic map to obtain the target map.

In some embodiments, before the step in which the global planning path in the target map is determined according to the current position of the robot and the end position in the navigation request, the method further includes the steps below. A grid corresponding to an environment where the robot is located is acquired. The target map is determined according to the grid. In an exemplary embodiment, the steps in which the grid corresponding to the environment where the robot is located is acquired and the target map is determined according to the grid may include: acquiring a basic map corresponding to the environment where the robot is located, and superposing the corresponding grid on the basic map to obtain the target map.

At present, for the indoor environment, a generally used map is a grid map. However, in terms of the grid map, generally, the grid dimension is relatively small, and a different grid arrangement and combination may be found at each search moment, thereby causing the global planning path to change relatively fast. This non-stability may be propagated to the following local planning and control level, making the robot shake and vibrate during the movement. At present, the topology road network is generally applied to the outdoor environment. In embodiments of the present disclosure, the topology road network applied to the outdoor environment may be applied to the indoor environment. That is, in embodiments of the present disclosure, the target map includes the topology road network map, and characteristics of the topology road network may be used to eliminate defects of the preceding grid map so that the robot moves more smoothly in the navigation process. The topology road network may be defined by a series of nodes and sides. The topology road network may be edited according to the environment characteristics in the working range of the robot. For example, description information such as a sequence number and a two-dimensional coordinate of each node in the topology road network, a sequence number of a node (i.e. the sequence number of the node that is directly connected to the each node through a side)corresponding to the each node may be recorded in a map file corresponding to the topology road network when the topology road network is edited. When the topology road network is edited, the environment characteristics that need to be considered may be determined according to the characteristics of the indoor environment. The environment characteristics that need to be considered may include the positions of the static obstacles such as tables, chairs, workbenches or walls. Multiple nodes may be designed according to the characteristics of the indoor environment, and it is ensured that paths corresponding to sides between nodes do not pass through the preceding static obstacles, i.e. may bypass the preceding obstacles that need to be considered.

In some embodiments, the step in which the local planning path corresponding to the initial local path is generated according to the initial local path and the local costmap includes the steps below. The local planning path corresponding to the initial local path is generated based on a preset search method according to the initial local path and the local costmap. The preset search method performs a search with an objective in which the local planning path approaches the initial local path and avoids an obstacle. The preset search method includes at least one of an A* algorithm, a D* algorithm, or the shortest path algorithm Dijkasta. The A* algorithm is a direct search method that is most effective for solving the shortest path in a static road network. The closer a distance estimation value in the A* algorithm is to the actual value, the faster a final search speed is. The A* algorithm has a directional search characteristic and a characteristic of quickly bypassing the obstacles. Therefore, the A* algorithm may be used to quickly and accurately generate the local planning path that fits the initial local path and has no collisions. The D* algorithm is a dynamic heuristic path search algorithm and has the characteristic of calculating the shortest path in the case where the external environment continuously changes. Therefore, for the case where the number of dynamic obstacles in the local planning range is relatively large, the robot can more flexibly and accurately bypass the dynamic obstacles, thereby effectively avoiding collisions between the robot and the dynamic obstacles.

In some embodiments, the step in which the navigation control instruction of the robot is generated according to the local planning path and the preset robot model corresponding to the robot includes the steps below. A first robot state corresponding to a local start point in the local planning path and a second robot state corresponding to a local end point in the local planning path are acquired. A navigation control instruction corresponding to a final navigation path in a next control step of the robot is generated by using the local planning path, the first robot state, the second robot state, the preset robot model corresponding to the robot, and a control step.

The robot state may include, for example, at least one of a motion state or a posture state (i.e. a posture, such as an orientation angle) of the robot, and may further include coordinate information of the position where the robot is located. The control step may be understood as a time interval at which the navigation control instruction is consecutively sent twice. The final navigation path may be understood as a navigation path used to indicate the actual movement trajectory of the robot. The navigation control instruction corresponding to the final navigation path may be understood as the control instruction that needs to be output to the robot to control the robot to move according to the final navigation path.

In an exemplary embodiment, the navigation control instruction corresponding to the final navigation path in the next control step of the robot may be generated by using the local planning path, the first robot state, the second robot state, the preset robot model corresponding to the robot, and the control step based on a model predictive control algorithm. The mechanism of action of the model predictive control (MPC) algorithm may be described as follows. At each sampling moment, a finite-time open-loop optimization problem is solved online according to current measurement information obtained, and a first element of a control sequence obtained is applied to a controlled object. At a next sampling moment, the preceding process is repeated. That is, a new measurement value is used as an initial condition for predicting future dynamics of the system in this case, and an optimization problem is refreshed and resolved. The MPC algorithm has a hard constraint satisfaction characteristic and a forward-looking closed-loop control characteristic. The preset robot model corresponding to the robot is introduced into the MPC algorithm, and collision-free trajectory generation and optimal control signal generation are implemented in conjunction with the A* algorithm and the MPC algorithm. The quality of control instruction may be designed by multiple conflicting indicators, such as a tracking accuracy and a control signal change rate. The control signal needs to be constantly adjusted so that the actual position of the robot closely matches an expected position. Otherwise, if the control signal change rate is very small, the actual position of the robot will deviate greatly from the expected position.

Through the preceding design, the generated control signal can acquire an optimal balance point under several evaluation criteria. That is, the navigation control instructions corresponding to different moments of the robot may be obtained more accurately, thereby accurately controlling the movement of the robot.

In some embodiments, the step in which the navigation control instruction is generated corresponding to the final navigation path in the next control step of the robot by using the local planning path, the first robot state, the second robot state, the preset robot model corresponding to the robot, and the control step includes the steps below. A cost function and a constraint condition are constructed by using the local planning path, the first robot state, the second robot state, the preset robot model corresponding to the robot, and the control step based on a model predictive control algorithm. The cost function includes a parameter corresponding to the navigation control instruction. The cost function is solved based on the constraint condition with an objective in which the cost function has a minimum value to obtain the navigation control instruction corresponding to the final navigation path in the next control step of the robot. Advantages of such setting are that: The cost function and the constraint condition are properly constructed so that under the constraint of the constraint condition, in the case where the cost function is the minimum value, parameter values of parameters related to the navigation control instruction and included in the cost function can be quickly obtained, thereby obtaining the navigation control instruction corresponding to the final navigation path, and improving the navigation control efficiency.

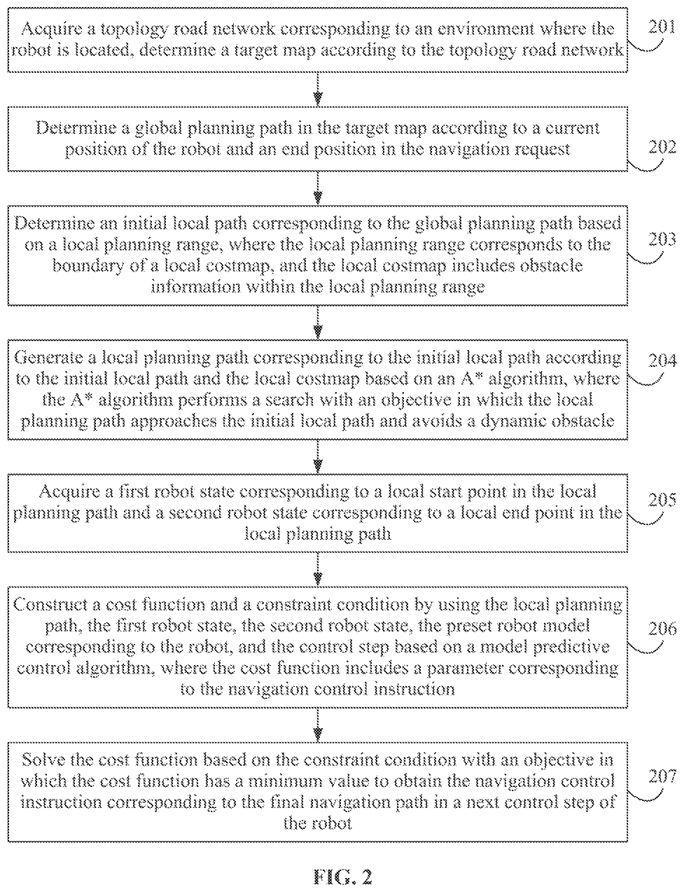

FIG. 2 is a flowchart of a navigation method according to an embodiment of the present disclosure. Refining is performed on the basis of the preceding optional embodiments. As shown in FIG. 2, the method may include the steps below.

In step 201: a topology road network corresponding to an environment where the robot is located is acquired, and a target map is determined according to the topology road network.

Exemplarily, the indoor environment where the robot needs to work may be collected in advance. For example, a basic map of the indoor environment is constructed by the SLAM technology, an operating area of the robot in the basic map is designed and delimited according to actual service requirements, and then the topology road network (hereinafter referred to as a road network) is drawn, and the corresponding topology road network is superposed on the basic map to obtain the target map.

In step 202: a global planning path in the target map is determined according to a current position of the robot and an end position in a navigation request.

For example, when the target map includes the topology road network, an initial state point (the current position) of the robot and a final state point (the end position in the navigation request) of the robot are provided so that a side that has the shortest vertical distance and whose vertical line does not intersect the obstacles may be found from all sides, and the coordinate of a point closest to a requested state point (the initial state point or the final state point) on the side is used as a path (the part of the global planning path)connecting the requested state point and the road network. After that, a series of road segments connecting a point closest to the start point and a point closest to the end point are found from the road network. Finally, the global planning path connecting the initial state point and the final state point and passing through the series of road segments on the road network is found.

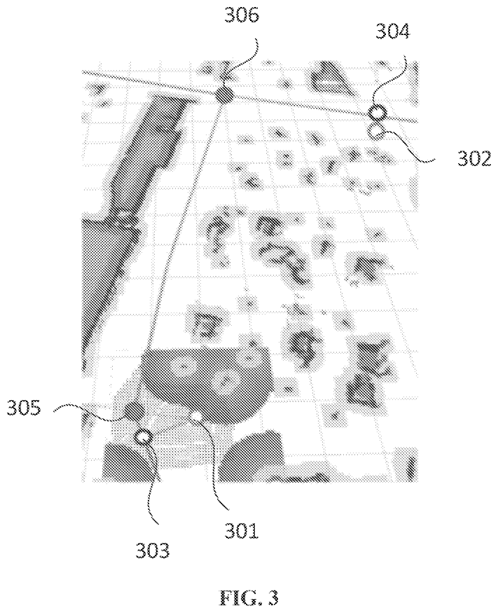

FIG. 3 is a schematic diagram of a global planning path according to an embodiment of the present disclosure. As shown in FIG. 3, six points are marked and respectively denoted as a first node 301, a second node 302, a third node 303, a fourth node 304, a fifth node 305, and a sixth node 306. The first node 301 is the current position of the robot, i.e. the initial state point. The second node 302 is the end position in the navigation request, i.e. the final state point. The third node 303 is a point closest to the first node 301 and has no collision on the topology road network. The fourth node 304 is a point closest to the second node 302 and has no collision on the topology road network. The fifth node 305 and the sixth node 306 are nodes included in the global planning path on the topology road network. The first node 301, the third node 303, the fifth node 305, the sixth node 306, the fourth node 304, and the second node 302 are connected in sequence to obtain the global planning path.

In step 203: an initial local path corresponding to the global planning path based on a local planning range is determined, where the local planning range corresponds to the boundary of a local costmap, and the local costmap includes obstacle information within the local planning range.

Exemplarily, a local planning period (such as 0.05 seconds) corresponding to the local planning may be set. The steps 203 to 207 may be executed once in each local planning period.

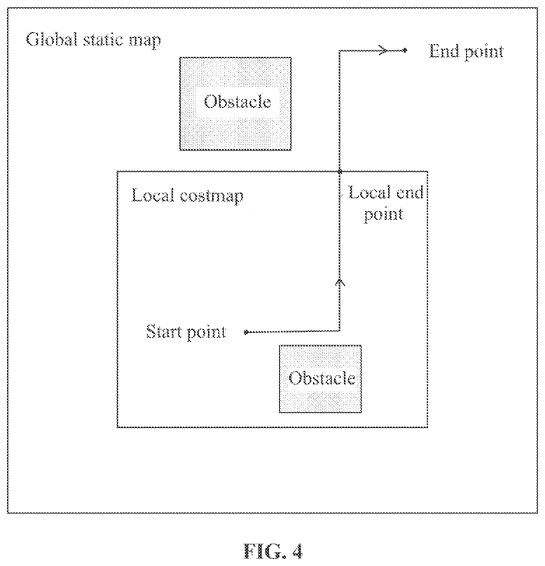

FIG. 4 is a schematic diagram of an initial local path according to an embodiment of the present disclosure. A global static map is the target map. A connection line from the start point to the end point is the global planning path. It can be seen that the global planning path avoids two obstacles. The local planning range is consistent with the boundary of the local costmap. An intersection point between the boundary of the local costmap and the global planning path is the end point of the initial local path, which is referred to as a local end point. The start point in the figure may also be understood as the start point of the initial local path, which is referred to as a local start point. As shown in the figure, the start point is located inside the local planning range. If the start point is located outside the local planning range, another intersection point that is relatively close to the start point and is between the boundary of the local costmap and the global planning path is referred to as the local start point. Part of the global planning path located inside the boundary of the local costmap and connected to the local start point and the local end point is the initial local path.

In step 204: a local planning path corresponding to the initial local path is generated according to the initial local path and the local costmap based on an A* algorithm, where the A* algorithm performs a search with an objective in which the local planning path approaches the initial local path and avoids a dynamic obstacle.

FIG. 5 is a schematic diagram of a local planning path according to an embodiment of the present disclosure. As shown in FIG. 5, the dynamic obstacle appears on the initial local path, and a curve from the start point to the local end point is the local planning path. It can be seen that the local planning path generated according to the initial local path and the local costmap based on the A* algorithm avoids the dynamic obstacle and is as close to a reference path (i.e. the initial local path) as possible.

In step 205: a first robot state corresponding to a local start point in the local planning path and a second robot state corresponding to a local end point in the local planning path are acquired.

In step 206: a cost function and a constraint condition are constructed by using the local planning path, the first robot state, the second robot state, the preset robot model corresponding to the robot, and the control step based on a model predictive control algorithm. The cost function includes a parameter corresponding to the navigation control instruction.

In step 207: the cost function is solved based on the constraint condition with an objective in which the cost function has a minimum value to obtain the navigation control instruction corresponding to the final navigation path in a next control step of the robot.

Exemplarily, in the process of determining the navigation control instruction based on the model predictive control algorithm, it is possible to, in conjunction with the preset robot model, such as a kinematics model, use a control cost (such as a relatively small steering angle change, a relatively small accelerated velocity change or a relatively small retarded velocity change, or the like) as low as possible, and track as much as possible, i.e. drive according to the local planning path as much as possible to obtain the navigation control instruction.

Exemplarily, after the navigation control instruction is obtained, the navigation control instruction may be sent to a motion mechanism of the robot to instruct the motion mechanism to control the autonomous movement of the robot according to the navigation control instruction.

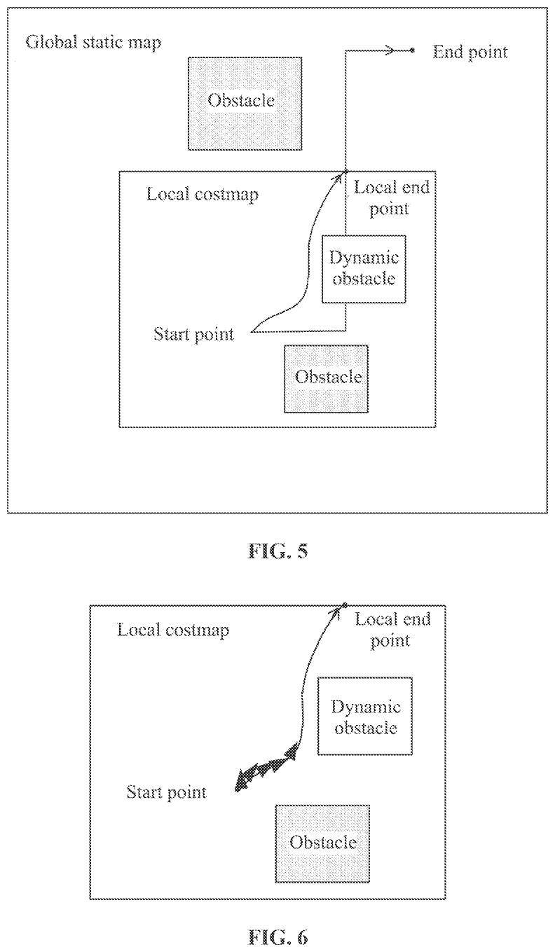

FIG. 6 is a schematic diagram of a robot trajectory according to an embodiment of the present disclosure. As shown in FIG. 6, a solid black arrow may represent a motion trajectory of the robot (corresponding to the final navigation path). Five solid black arrows are shown in the figure. The number of solid black arrows may represent a control step. The control step shown in FIG. 6 is 5. It can be seen from FIG. 6 that the final navigation path basically matches the local planning path, implementing a relatively precise tracking effect.

In the navigation method provided in embodiments of the present disclosure, a global planning manner based on the topology road network, avoiding a global path change caused by frequently switching an optimal path in a grid map search algorithm solution, greatly improving the global path stability. The manually delimited road network avoids an area that the robot is not expected to pass through, greatly improving the controllability of the moving range of the robot. The method synthetizes an A*-based local planning and an MPC-based control algorithm method, comprehensively utilizing the directional search characteristic and the characteristic of quickly bypassing the obstacles of the A* and the hard constraint satisfaction characteristic and the forward-looking closed-loop control characteristic of the MPC optimal control, successfully replacing a widely used local planning open-source module, such as a dynamic window (DWA) and a pure pursuit, more rationally controlling the autonomous movement of the robot, and ensuring the stability, the security, and the smoothness of the autonomous navigation movement of the robot.

In some embodiments, the cost function includes a first expression for representing tracking accuracy of the robot and a second expression for representing a size of a navigation control signal of the robot and a change rate of the navigation control signal of the robot. The constraint condition includes a third expression for representing a preset robot model constraint of the robot and a fourth expression for representing a value range of a control signal of the robot. Advantages of optimization herein are that: the hard constraint satisfaction characteristic and the forward-looking closed-loop control characteristic of the MPC optimal control can be fully utilized, and the high-accuracy tracking of the robot can be implemented at the lowest possible control cost. That is, the control cost and the planning path execution accuracy are both considered.

In some embodiments, the robot includes a differential drive robot. The corresponding preset robot model may be a preset robot kinematics model. Correspondingly, the third expression for representing the preset robot model constraint of the robot may be the third expression for representing the kinematics constraint manner of the robot.

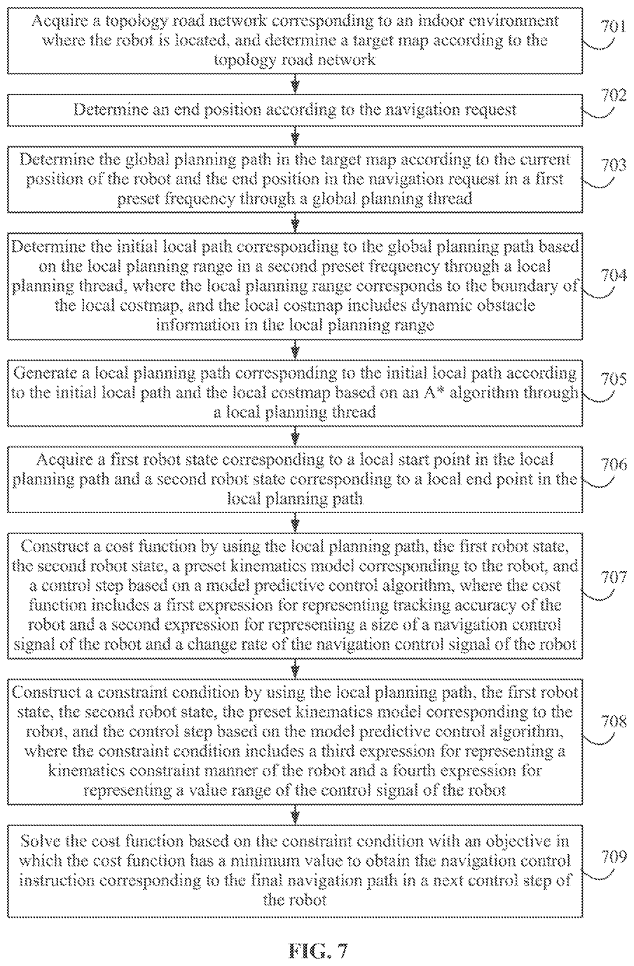

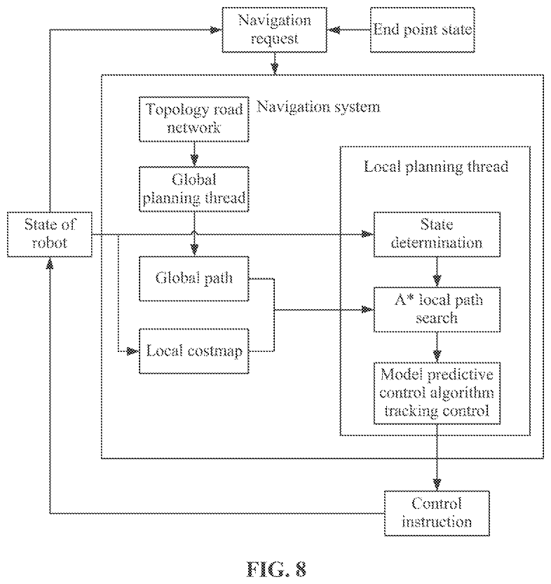

FIG. 7 is a flowchart of a navigation method according to an embodiment of the present disclosure. The differential drive robot is used as an example to perform optimization based on the preceding optional embodiments. FIG. 8 is an architecture diagram of a navigation method according to an embodiment of the present disclosure. The solutions may be further understood in conjunction with FIG. 8.

As shown in FIG. 8, after generating the navigation request, the robot includes an end point state included in the navigation request, notifies the navigation system of the navigation request including the end point state and updates the local costmap in real time. The navigation system uses a hierarchical design and includes a global planning thread (the working frequency may be denoted as a first preset frequency, such as 10 HZ) and a local planning thread (the working frequency may be denoted as a second preset frequency, such as 20 HZ). The global planning path obtained by the global planning thread and the obstacle information updated by the local costmap in real time are transmitted together to an A* local path searching module in the local planning thread. The A* local path searching module generates the local planning path having no collision and fitting the global planning path and transmits the local planning path to an MPC tracking control module. Finally, the MPC tracking control module outputs a navigation control signal to drive the robot to move. In the preceding process, the local planning thread may also be responsible for acquiring the state of the robot, such as a position coordinate and an orientation angle, adjusting an in-situ rotation posture of the robot, and outputting an adjustment instruction together to the robot so that the robot cooperatively adjusts the in-situ rotation posture in the process of movement according to the navigation control instruction.

As shown in FIG. 7, the method includes the steps below.

In step 701: a topology road network corresponding to an indoor environment where the robot is located is acquired, and a target map is determined according to the topology road network.

In step 702: an end position is determined according to the navigation request.

In step 703: the global planning path in the target map is determined according to the current position of the robot and the end position in the navigation request in a first preset frequency through a global planning thread.

The first preset frequency may be, for example, 10 HZ.

In step 704: the initial local path corresponding to the global planning path is determined based on the local planning range in a second preset frequency through a local planning thread, where the local planning range corresponds to the boundary of the local costmap, and the local costmap includes dynamic obstacle information in the local planning range.

A general indoor scenario requires a real-time calculation frequency of 10 HZ. The second preset frequency may be set higher, for example, 20 HZ, to implement a more accurate tracking.

In step 705: a local planning path corresponding to the initial local path is generated according to the initial local path and the local costmap based on an A* algorithm through a local planning thread.

In step 706: a first robot state corresponding to a local start point in the local planning path and a second robot state corresponding to a local end point in the local planning path are acquired.

In step 707: a cost function is constructed by using the local planning path, the first robot state, the second robot state, a preset kinematics model corresponding to the robot, and a control step based on a model predictive control algorithm. The cost function includes a first expression for representing tracking accuracy of the robot and a second expression for representing a size of a navigation control signal of the robot and a change rate of the navigation control signal of the robot.

Exemplarily, the constructed cost function may be represented by the following formula:

$$f = {\sum }_{t = 0}^{t = N} ( {\hat{s}}_{t} - {s}_{t} ) {Q ( {\hat{s}}_{t} - {s}_{t} )}^{T} + {u}_{t} {Ru}_{t}^{T} + {A}_{t} + {A}_{t}$$

f denotes the cost function. Four terms are provided on the right side of the preceding equation. The first term is the first expression, and the second term, the third term, and the fourth term are the second expression. N denotes a predictive step of the MPC (i.e. the control step). sₜ=[xₜ, yₜ], ŝₜ^{T}=[\hat{x}ₜ, ŷₜ]^{T}, sₜ=[xₜ, yₜ], uₜ=[vₜ, ωₜ]. xₜ denotes a coordinate of the robot on an x-axis at a moment t. \hat{x}ₜ denotes a coordinate of a reference path point (i.e. a point on the local planning path) of the robot on the x-axis at the moment t. yₜ denotes a coordinate of the robot on a y-axis at the moment t. ŷₜ denotes a coordinate of the reference path point on the x-axis of the robot at the moment t. aₜ denotes an accelerated velocity of the robot at the moment t. αₜ denotes an angular accelerated velocity of the robot at the moment t. sₜ denotes a state vector of the robot at the moment t. uₜ denotes a control vector of the robot at the moment t. Q denotes a state tracking accuracy weight matrix. R denotes a control signal numerical weight matrix. Aₜ denotes an accelerated velocity soft constraint variable. Aₜ denotes an angular accelerated velocity soft constraint variable. Values of Q and R may be set according to the actual situation, for example,

$$Q = [ \begin{matrix}6 & 0 \\ 0 & 6\end{matrix} ] , R = [ \begin{matrix}1 & 0 \\ 0 & 1\end{matrix} ] .$$

In step 708: a constraint condition is constructed by using the local planning path, the first robot state, the second robot state, the preset kinematics model corresponding to the robot, and the control step based on the model predictive control algorithm, where the constraint condition includes a third expression for representing a kinematics constraint manner of the robot and a fourth expression for representing a value range of the control signal of the robot.

Exemplarily, the constructed cost function may be represented by the following formula:

for each t ∈ [0, N] (1)

xₜ₊₁=xₜ+vₜ*cos(θₜ)*dt (2)

yₜ₊₁=yₜ+vₜ*sin(θₜ)*dt (3)

θₜ₋₁=ωₜ*dt (4)

vₘᵢₙ≤vₜ≤vₘₐₓ, ωₘᵢₙ≤ωₜ≤ωₘₐₓ (5)

aₘᵢₙ−Aₜ≤vₜ₊₁−vₜ≤aₘₐₓ+Aₜ, αₘᵢₙ−Aₜ≤ωₜ₊₁−ωₜ≤αₘₐₓ+Aₜ (6)

(2), (3), and (4) are the third expressions, and (5) and (6) are the fourth expressions. ωₘᵢₙ denotes the minimum angular velocity. ωₘₐₓ denotes the maximum angular velocity. vₘᵢₙ denotes the minimum linear velocity. vₘₐₓ denotes the maximum linear velocity. αₘᵢₙ denotes the minimum accelerated velocity. αₘₐₓ denotes the maximum accelerated velocity. αₘᵢₙ denotes the minimum angular accelerated velocity. αₘₐₓ denotes the maximum angular accelerated velocity. θₜ denotes an orientation angle at the moment t. θₜ₊₁ denotes an orientation angle at the moment t+1.

In step 709: the cost function is solved based on the constraint condition with an objective in which the cost function has a minimum value to obtain the navigation control instruction corresponding to the final navigation path in a next control step of the robot.

Exemplarily, for the preceding cost function and the constraint condition, a state sequence [s₀, . . . , s_{N}] and a control signal sequence [u₀, . . . , u_{N-1}] may be obtained so that in the case where the constraint condition is satisfied, the cost function f is the minimum value. Since the MPC algorithm is a closed-loop control method, the first entry u₀ in the obtained control sequence may be used as the control signal for execution, i.e. the navigation control instruction corresponding to the final navigation path in the next control step of the robot.

In an exemplary embodiment, a non-linear solver may be used to solve to obtain a time path point (i.e. the state vector) of a fixed control step and a forthcoming next-moment control instruction (i.e. the control signal). The control signal may include a linear speed and an angular speed of a differential robot. The specific type of the non-linear solver is not limited, for example, may be CasADi or an interior point optimizer method (IPOPT).

The navigation method provided in embodiments of the present disclosure may be applicable to the case of performing the autonomous movement navigation on the differential drive robot. The global planning is performed based on the topology road network, avoiding a global path instability caused by frequently switching an optimal path in a grid map search algorithm solution, greatly improving the global path stability. The manually delimited road network avoids an area that the robot is not expected to pass through, greatly improving the controllability of the moving range of the robot. The method synthetizes an A*-based local planning and an MPC-based control algorithm, comprehensively utilizing the directional search characteristic and the characteristic of quickly bypassing the obstacles of the A* and the hard constraint satisfaction characteristic and the forward-looking closed-loop control characteristic of the MPC optimal control. The kinematics model according with the movement characteristics of the differential drive robot is introduced into the MPC-based control algorithm, implementing the balance of optimal trajectory accuracy and minimal control signal change satisfying the constraint of the kinematics model of the differential drive mobile robot, more rationally controlling the autonomous movement of the robot, and ensuring the stability, the security, and the smoothness of the autonomous navigation movement of the robot. In addition, limiting the control signal change can also reduce the power consumption of the robot and improve the operating time of the autonomously powered robot.

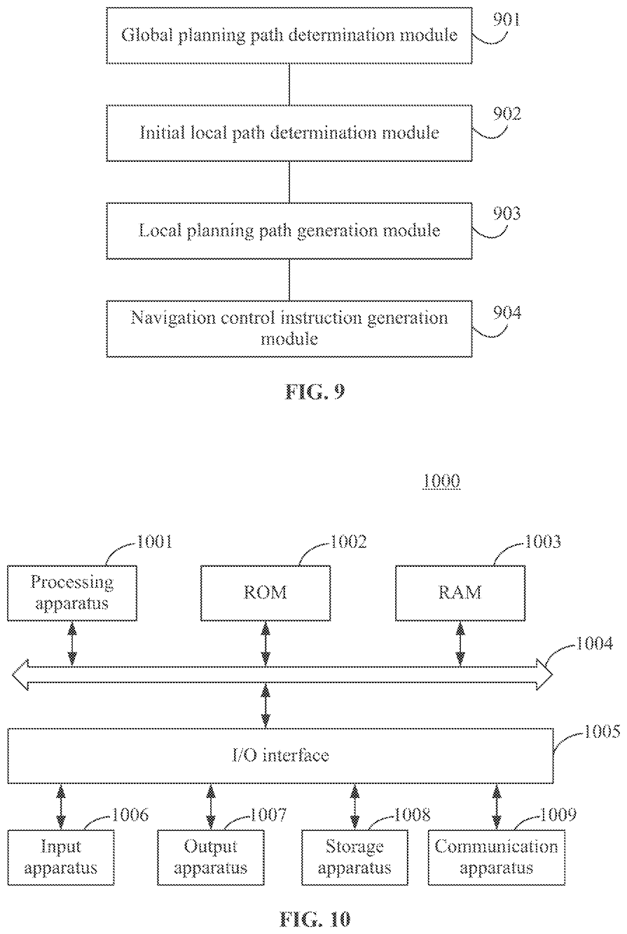

FIG. 9 is a block diagram of a navigation apparatus according to an embodiment of the present disclosure. The apparatus may be implemented by software and/or hardware. Generally, the apparatus may be integrated into an electronic device. The apparatus performs navigation by executing a navigation method. The electronic device may be a robot, or a stand-alone device that can communicate with the robot and has a navigation function. As shown in FIG. 9, the apparatus includes: a global planning path determination module 901, an initial local path determination module 902, a local planning path generation module 903, and a navigation control instruction generation module 904.

The global planning path determination module 901 is configured to determine a global planning path in a target map according to a current position of a robot and an end position in a navigation request.

The initial local path determination module 902 is configured to determine an initial local path corresponding to the global planning path based on a local planning range, wherein the local planning range corresponds to a boundary of a local costmap, and the local costmap includes obstacle information within the local planning range.

The local planning path generation module 903 is configured to generate a local planning path corresponding to the initial local path according to the initial local path and the local costmap.

The navigation control instruction generation module 904 is configured to generate a navigation control instruction of the robot according to the local planning path and a preset robot model corresponding to the robot.

In the navigation apparatus provided in embodiments of the present disclosure, first, the global planning path in the target map is determined according to the current position of the robot and the terminal position in the navigation request. Then, the initial local path corresponding to the global planning path is determined based on the local planning range, where the local planning range corresponds to the boundary of the local costmap, and the local costmap includes the obstacle information within the local planning range. Then, the local planning path corresponding to the initial local path is generated according to the initial local path and the local costmap. Finally, the navigation control instruction of the robot is generated according to the local planning path and the preset robot model corresponding to the robot. In the preceding technical solutions, part of the global planning path corresponding to the local planning range is determined as a current initial local path on the basis of the global planning path, and a more accurate local planning path is obtained on the basis of the initial local path in conjunction with the obstacle information. In the process of generating the navigation control instruction according to the local planning path, constraints of the preset robot model corresponding to the robot are considered so that the generated navigation control instruction is more suitable for features of the robot, avoiding the robot from being stuck or vibrated during the movement according to the navigation control instruction, and improving the smoothness of the autonomous movement of the robot.

In an exemplary embodiment, the apparatus may further include: a first target map acquisition module configured to: before the global planning path in the target map is determined according to the current position of the robot and the end position in the navigation request, acquire a topology road network corresponding to an environment where the robot is located, and determine the target map according to the topology road network.

In an exemplary embodiment, the apparatus may further include: a second target map acquisition module configured to: before the global planning path in the target map is determined according to the current position of the robot and the end position in the navigation request, acquire a grid corresponding to an environment where the robot is located, and determine the target map according to the grid.

In an exemplary embodiment, the step in which a local planning path corresponding to the initial local path is generated according to the initial local path and the local costmap includes the steps below. The local planning path corresponding to the initial local path is generated based on a preset search method according to the initial local path and the local costmap. The preset search method performs a search with an objective in which the local planning path approaches the initial local path and avoids an obstacle. The preset search method includes at least one of an A* algorithm, a D* algorithm, or the shortest path algorithm Dijkasta.

In an exemplary embodiment, the step in which the navigation control instruction of the robot is generated according to the local planning path and the preset robot model corresponding to the robot includes the steps below. A first robot state corresponding to a local start point in the local planning path and a second robot state corresponding to a local end point in the local planning path are acquired. A navigation control instruction corresponding to a final navigation path in a next control step of the robot is generated by using the local planning path, the first robot state, the second robot state, the preset robot model corresponding to the robot, and a control step.

In an exemplary embodiment, the step in which the navigation control instruction corresponding to the final navigation path in the next control step of the robot is generated by using the local planning path, the first robot state, the second robot state, the preset robot model corresponding to the robot, and the control step includes the steps below. A cost function and a constraint condition are constructed by using the local planning path, the first robot state, the second robot state, the preset robot model corresponding to the robot, and the control step based on a model predictive control algorithm. The cost function includes a parameter corresponding to the navigation control instruction. The cost function is solved based on the constraint condition with an objective in which the cost function has a minimum value to obtain the navigation control instruction corresponding to the final navigation path in the next control step of the robot.

In an exemplary embodiment, the robot includes a differential drive robot. The cost function includes a first expression for representing tracking accuracy of the robot and a second expression for representing a size of a navigation control signal of the robot and a change rate of the navigation control signal of the robot. The constraint condition includes a third expression for representing a kinematics constraint manner of the robot and a fourth expression for representing a value range of a control signal of the robot.

In an exemplary embodiment, the preset robot model includes at least one of a preset robot mechanical model, a preset robot kinematics model, or a preset robot dynamics model.

Referring to FIG. 10, FIG. 10 shows a structure diagram of an electronic device 1000 suitable for implementing embodiments of the present disclosure. The electronic device in the embodiments of the present disclosure may include, but is not limited to, a mobile terminal or a fixed terminal. The mobile terminal may be, for example, a mobile phone, a laptop, a digital radio receiver, a personal digital assistant (PDA), a tablet computer, a portable media player (PMP), or a vehicle-mounted terminal (such as a vehicle-mounted navigation terminal). The fixed terminal may be, for example, a digital television (DTV) or a desktop computer. The electronic device shown in FIG. 10 is merely an example and should not impose any limitation on the function and scope of use of the embodiments of the present disclosure.

As shown in FIG. 10, the electronic device 1000 may include a processing apparatus (such as a central processing unit or a graphics processing unit) 1001. The processing apparatus 1002 may perform various appropriate actions and processing according to a program stored in a read-only memory (ROM) 1002 or a program loaded from a storage apparatus 1008 into a random-access memory (RAM) 1003. The RAM 1003 also stores various programs and data required for the operation of the computer device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 such as a touch screen, a touchpad, a keyboard, a mouse, a camera, a microphone, an accelerometer and a gyroscope; an output apparatus 1007 such as a liquid crystal display (LCD), a speaker and a vibrator; the storage apparatus 1008 such as a magnetic tape and a hard disk; and a communication apparatus 1009. The communication apparatus 1009 may allow the electronic device 1000 to perform wireless or wired communication with other devices to exchange data. Although FIG. 10 illustrates the electronic device 1000 having various apparatuses, it is to be understood that not all of the illustrated apparatuses are implemented or available. Alternatively, more or fewer apparatuses may be implemented.

Particularly, according to embodiments of the present disclosure, the processes described above with reference to the flowcharts may be implemented as computer software programs. For example, an embodiment of the present disclosure includes a computer program product. The computer program product includes a computer program carried on a non-transitory computer-readable medium. The computer program includes program codes for performing the methods illustrated in the flowcharts. In such an embodiment, the computer program may be downloaded and installed from a network through the communication apparatus 1009, installed from the storage apparatus 1008, or installed from the ROM 1002. When the computer program is executed by the processing apparatus 1001, the preceding functions defined in the methods in the embodiments of the present disclosure are implemented.

It is to be noted that the preceding computer-readable medium in the present disclosure may be a computer-readable signal medium or a computer-readable storage medium, or any combination thereof. The computer-readable storage medium may be, for example, but is not limited to, an electrical, magnetic, optical, electromagnetic, infrared or semiconductor system, apparatus or device, or any combination thereof. More specific examples of the computer-readable storage medium may include, but are not limited to, an electrical connection with at least one wire, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical memory device, a magnetic memory device, or any appropriate combination thereof. In the present disclosure, the computer-readable storage medium may be any tangible medium including or storing a program. The program may be used by or in conjunction with an instruction execution system, apparatus, or device. In the present disclosure, the computer-readable signal medium may include a data signal propagated in baseband or as part of a carrier wave, where computer-readable program codes are carried in the data signal. The data signal propagated in this manner may be in various forms, including, but not limited to, an electromagnetic signal, an optical signal, or any appropriate combination thereof. The computer-readable signal medium may also be any computer-readable medium other than the computer-readable storage medium. The computer-readable signal medium may send, propagate or transmit a program used by or in conjunction with an instruction execution system, apparatus, or device. The program codes included on the computer-readable medium may be transmitted via any appropriate medium including, but not limited to, a wire, an optical cable, a radio frequency (RF), or any appropriate combination thereof

The preceding computer-readable medium may be included in the preceding computer device or may exist alone without being assembled into the computer device.

The computer-readable medium carries at least one program which, when executed by the electronic device, cause the electronic device to: determine a global planning path in a target map according to a current position of a robot and an end position in a navigation request; determine an initial local path corresponding to the global planning path based on a local planning range, where the local planning range corresponds to the boundary of a local costmap, and the local costmap includes obstacle information within the local planning range; generate a local planning path corresponding to the initial local path according to the initial local path and the local costmap; and generate a navigation control instruction of the robot according to the local planning path and a preset robot model corresponding to the robot.

Computer program codes for executing operations in the present disclosure may be written in one or more programming languages or a combination thereof. The preceding programming languages include, but are not limited to, an object-oriented programming language such as Java, Smalltalk, or C++ and may also include a conventional procedural programming language such as C or a similar programming language. The program codes may be executed entirely on a machine, partly on a machine, as a stand-alone software package, partly on a machine and partly on a remote machine, or entirely on a remote machine or a server. In the case where the remote computer is involved, the remote computer may be connected to the user computer via any type of network including a local area network (LAN) or a wide area network (WAN) or may be connected to an external computer (for example, via the Internet through an Internet service provider).

The flowcharts and block diagrams in the drawings show the possible architecture, functions and operations of the system, method and computer program product according to various embodiments of the present disclosure. In this regard, each block in the flowcharts or block diagrams may represent a module, a program segment or part of codes. The module, program segment or part of codes contains at least one executable instruction for implementing specified logical functions. It is also to be noted that in some alternative implementations, the functions marked in the blocks may be implemented in an order different from those marked in the drawings. For example, two successive blocks may, in fact, be performed substantially in parallel or in a reverse order, which depends on the functions involved. It is also to be noted that each block in the block diagrams and/or flowcharts and a combination of blocks in the block diagrams and/or flowcharts may be implemented by a special-purpose hardware-based system executing specified functions or operations or may be implemented by a combination of special-purpose hardware and computer instructions.

The modules involved in the embodiments of the present disclosure may be implemented by software or hardware. The names of the modules are not intended to limit the modules themselves. For example, the global planning path determination module may also be described as “a module determining the global planning path in the target map according to the current position of the robot and the end position in the navigation request”.

The functions described herein may be performed, at least partially, by at least one hardware logic component. For example, without limitation, example types of hardware logic components that can be used include a field-programmable gate array (FPGA), an application-specific integrated circuit (ASIC), an application-specific standard product (ASSP), a system on a chip (SOC), a complex programmable logic device (CPLD) and the like.

In the context of the present disclosure, a machine-readable medium may be a tangible medium that may include or store a program used by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any appropriate combination thereof. More specific examples of the machine-readable storage medium may include an electrical connection with at least one wire, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical memory device, a magnetic memory device, or any appropriate combination thereof

According to at least one embodiment of the present disclosure, a navigation method is provided. The method includes the steps below.

A global planning path in a target map is determined according to a current position of a robot and a terminal position in a navigation request.

An initial local path corresponding to the global planning path based on a local planning range is determined. The local planning range corresponds to the boundary of a local costmap. The local costmap includes obstacle information within the local planning range.

A local planning path corresponding to the initial local path is generated according to the initial local path and the local costmap.

A navigation control instruction of the robot is generated according to the local planning path and a preset robot model corresponding to the robot.

In an exemplary embodiment, before the step in which the global planning path in the target map is determined according to the current position of the robot and the end position in the navigation request, the method further includes the steps below.

A topology road network corresponding to an environment where the robot is located is acquired. The target map is determined according to the topology road network.

In an exemplary embodiment, before the step in which the global planning path in the target map is determined according to the current position of the robot and the end position in the navigation request, the method further includes the steps below.

A grid corresponding to an environment where the robot is located is acquired. The target map is determined according to the grid.

In an exemplary embodiment, the step in which the local planning path corresponding to the initial local path is generated according to the initial local path and the local costmap includes the steps below.

The local planning path corresponding to the initial local path is generated based on a preset search method according to the initial local path and the local costmap. The preset search method performs a search with an objective in which the local planning path approaches the initial local path and avoids an obstacle. The preset search method includes at least one of an A* algorithm, a D* algorithm, or the shortest path algorithm Dijkasta.

In an exemplary embodiment, the step in which the navigation control instruction of the robot is generated according to the local planning path and the preset robot model corresponding to the robot includes the steps below.

A first robot state corresponding to a local start point in the local planning path and a second robot state corresponding to a local end point in the local planning path are acquired.

A navigation control instruction corresponding to a final navigation path in a next control step of the robot is generated by using the local planning path, the first robot state, the second robot state, the preset robot model corresponding to the robot, and a control step.

In an exemplary embodiment, the step in which the navigation control instruction is generated corresponding to the final navigation path in the next control step of the robot by using the local planning path, the first robot state, the second robot state, the preset robot model corresponding to the robot, and the control step includes the steps below.

A cost function and a constraint condition are constructed by using the local planning path, the first robot state, the second robot state, the preset robot model corresponding to the robot, and the control step based on a model predictive control algorithm. The cost function includes a parameter corresponding to the navigation control instruction.

The cost function is solved based on the constraint condition with an objective in which the cost function has a minimum value to obtain the navigation control instruction corresponding to the final navigation path in the next control step of the robot.

In an exemplary embodiment, the robot includes a differential drive robot.

The cost function includes a first expression for representing tracking accuracy of the robot and a second expression for representing a size of a navigation control signal of the robot and a change rate of the navigation control signal of the robot.

The constraint condition includes a third expression for representing a kinematics constraint manner of the robot and a fourth expression for representing a value range of a control signal of the robot.

In an exemplary embodiment, the preset robot model includes at least one of a preset robot mechanical model, a preset robot kinematics model, or a preset robot dynamic model.

According to at least one embodiment of the present disclosure, a navigation apparatus is provided. The apparatus includes a global planning path determination module, an initial local path determination module, a local planning path generation module, and a navigation control instruction generation module.

The global planning path determination module is configured to determine a global planning path in a target map according to a current position of a robot and an end position in a navigation request.

The initial local path determination module is configured to determine an initial local path corresponding to the global planning path based on a local planning range. The local planning range corresponds to the boundary of a local costmap, and the local costmap includes obstacle information within the local planning range.

The local planning path generation module is configured to generate a local planning path corresponding to the initial local path according to the initial local path and the local costmap.

The navigation control instruction generation module is configured to generate a navigation control instruction of the robot according to the local planning path and a preset robot model corresponding to the robot.

The preceding description is merely illustrative of preferred embodiments of the present disclosure and the technical principles used therein. It is to be understood by those skilled in the art that the scope of disclosure involved in the present disclosure is not limited to the technical solutions formed by particular combinations of the preceding technical characteristics and should also cover other technical solutions formed by any combination of the preceding technical characteristics or their equivalents without departing from the concept of the present disclosure. For example, technical solutions formed by the substitutions of the preceding characteristics with the technical characteristics (not limited to being) disclosed in the present disclosure and having similar functions.

Additionally, although various operations are described in a particular order, it is not a must to perform these operations in this particular order or in sequential order. In certain circumstances, multitasking and parallel processing may be advantageous. Similarly, although several specific implementation details are included in the preceding discussion, these should not be construed as limitations on the scope of the present disclosure. Certain characteristics described in the context of separate embodiments may also be implemented in combination in a single embodiment. Conversely, various characteristics described in the context of a single embodiment may also be implemented in multiple embodiments, individually, or in any suitable sub-combination.

Although the subject matter is described in the language specific to structural characteristics and/or methodological logic acts, it is to be understood that the subject matter defined in the appended claims is not necessarily limited to the specific characteristics or acts described above. Conversely, the particular characteristics and acts described above are merely example forms for implementing the claims.

What is claimed is:

1. A navigation method, comprising:
determining a global planning path in a target map according to a current position of a robot and an end position in a navigation request;
determining an initial local path corresponding to the global planning path based on a local planning range, wherein the local planning range corresponds to a boundary of a local costmap, and the local costmap comprises obstacle information within the local planning range; and
generating a local planning path corresponding to the initial local path according to the initial local path and the local costmap; and
generating a navigation control instruction of the robot according to the local planning path and a preset robot model corresponding to the robot.

2. The method of claim 1, before the determining a global planning path in a target map according to a current position of a robot and an end position in a navigation request, further comprising:
acquiring a topology road network corresponding to an environment where the robot is located, and determining the target map according to the topology road network.

3. The method of claim 1, before the determining a global planning path in a target map according to a current position of a robot and an end position in a navigation request, further comprising:
acquiring a grid corresponding to an environment where the robot is located, and determining the target map according to the grid.

4. The method of claim 1, wherein the generating a local planning path corresponding to the initial local path according to the initial local path and the local costmap comprises:
generating the local planning path corresponding to the initial local path based on a preset search method according to the initial local path and the local costmap, wherein the preset search method performs a search with an objective in which the local planning path approaches the initial local path and avoids an obstacle, and the preset search method comprises at least one of an A* algorithm, a D* algorithm, or a shortest path algorithm Dijkasta.

5. The method of claim 4, wherein the generating a navigation control instruction of the robot according to the local planning path and a preset robot model corresponding to the robot comprises:
acquiring a first robot state corresponding to a local start point in the local planning path and a second robot state corresponding to a local end point in the local planning path; and
generating a navigation control instruction corresponding to a final navigation path in a next control step of the robot by using the local planning path, the first robot state, the second robot state, the preset robot model corresponding to the robot, and a control step.

6. The method of claim 5, wherein the generating a navigation control instruction corresponding to a final navigation path in a next control step of the robot by using the local planning path, the first robot state, the second robot state, the preset robot model corresponding to the robot, and a control step comprises:
constructing, a cost function and a constraint condition by using the local planning path, the first robot state, the second robot state, the preset robot model corresponding to the robot, and the control step based on a model predictive control algorithm, wherein the cost function comprises a parameter corresponding to the navigation control instruction; and
solving the cost function based on the constraint condition with an objective in which the cost function has a minimum value to obtain the navigation control instruction corresponding to the final navigation path in the next control step of the robot.

7. The method of claim 6, wherein the robot comprises a differential drive robot; and
the cost function comprises a first expression for representing tracking accuracy of the robot and a second expression for representing a size of a navigation control signal of the robot and a change rate of the navigation control signal of the robot; and
the constraint condition comprises a third expression for representing a kinematics constraint manner of the robot and a fourth expression for representing a value range of a control signal of the robot.

8. The method of claim 1, wherein the preset robot model comprises at least one of a preset robot mechanical model, a preset robot kinematics model, or a preset robot dynamic model.

9. A navigation apparatus, comprising:
at least one processor; and
a memory configured to store at least one program;
wherein the at least one program, when executed by the at least one processor, causes the at least one processor to:
determine a global planning path in a target map according to a current position of a robot and an end position in a navigation request; and
determine an initial local path corresponding to the global planning path based on a local planning range, wherein the local planning range corresponds to a boundary of a local costmap, and the local costmap comprises obstacle information within the local planning range; and
generate a local planning path corresponding to the initial local path according to the initial local path and the local costmap; and
generate a navigation control instruction of the robot according to the local planning path and a preset robot model corresponding to the robot.

10. A non-transitory computer-readable storage medium storing a computer program which, when executed by a processor, implements the following:
determining a global planning path in a target map according to a current position of a robot and an end position in a navigation request;
determining an initial local path corresponding to the global planning path based on a local planning range, wherein the local planning range corresponds to a boundary of a local costmap, and the Local costmap comprises obstacle information within the local planning range; and
generating a local planning path corresponding to the initial local path according to the initial local path and the local costmap; and
generating a navigation control instruction of the robot according to the local planning path and a preset robot model corresponding to the robot.

11. (canceled)

12. The method of claim 2, wherein the preset robot model comprises at least one of a preset robot mechanical model, a preset robot kinematics model, or a preset robot dynamic model.

13. The method of claim 3, wherein the preset robot model comprises at least one of a preset robot mechanical model, a preset robot kinematics model, or a preset robot dynamic model.

14. The method of claim 4, wherein the preset robot model comprises at least one of a preset robot mechanical model, a preset robot kinematics model, or a preset robot dynamic model.

15. The method of claim 5, wherein the preset robot model comprises at least one of a preset robot mechanical model, a preset robot kinematics model, or a preset robot dynamic model.

16. The method of claim 6, wherein the preset robot model comprises at least one of a preset robot mechanical model, a preset robot kinematics model, or a preset robot dynamic model.

17. The method of claim 7, wherein the preset robot model comprises at least one of a preset robot mechanical model, a preset robot kinematics model, or a preset robot dynamic model.

18. The apparatus of claim 9, before the determining a global planning path in a target map according to a current position of a robot and an end position in a navigation request, the processor is further caused to:
acquire a topology road network corresponding to an environment where the robot is located, and determine the target map according to the topology road network.

19. The apparatus of claim 9, before the determining a global planning path in a target map according to a current position of a robot and an end position in a navigation request, the processor is further caused to:
acquire a grid corresponding to an environment where the robot is located, and determine the target map according to the grid.

20. The apparatus of claim 9, wherein the processor is configured to generate the local planning path corresponding to the initial local path according to the initial local path and the local costmap in the following manner:
generating the local planning path corresponding to the initial local path based on a preset search method according to the initial local path and the local costmap, wherein the preset search method based on the constraint condition with an objective in which the cost function has a minimum value the local planning path approaches the initial local path and avoids an obstacle, and the preset search method comprises at least one of an A* algorithm, a D* algorithm, or a shortest path algorithm Dijkasta.
